(19) United States
(12) Patent Application Publication
(10) Pub. No.: US 2021/0281962 A1
(43) Pub. Date: Sep. 9, 2021

(54) COMPOSITE MATERIAL FOR PRODUCING AN ACOUSTIC MEMBRANE

(71) Applicant: ISOVOLTA AG, Wiener Neudorf (AT)

(72) Inventors: Christian Zechner, Gröbming (AT); Peter Pertl, Graz (AT); José Antonio Garcia Garcia, Graz (AT); Christian Bertl, Bad Gleichenberg (AT)

(21) Appl. No.: 16/315,378

(22) PCT Filed: Jul. 4, 2017
(86) PCT No.: PCT/EP2017/066610

§ 371 Date: Jan. 4, 2019

(30) Foreign Application Priority Data
Jul. 6, 2016 (EP) 16178183.6

(51) Int. Cl. H04R 31/00; B32B 25/06; B32B 25/08; B32B 25/14; B32B 7/06; B29C 48/00; B29C 48/07; B29C 48/154; B32B 37/14; H04R 7/10

(52) U.S. Cl. CPC H04R 31/003; B32B 25/06; B32B 25/08; B32B 25/14; B32B 7/06; B29K 2083/00; B29C 48/07; B29C 48/154; B32B 37/14; H04R 7/10; B32B 2307/732; B29C 48/0021

(57) ABSTRACT

A composite material for producing an acoustic membrane, wherein the composite material comprises a silicone layer comprising an at least partially uncured silicone rubber and a support layer, wherein the support layer is adjacent to the silicone layer, as well as a method of preparing such a composite material and a process for producing an acoustic membrane from such a composite material.

The invention relates to a composite material for producing an acoustic membrane, a process for producing an acoustic membrane from the composite material as well as a method for preparing such a composite material.

### BACKGROUND OF THE INVENTION

Electromagnetic transducers are used for various types of loudspeakers and microphones, in particular also for miniature loudspeakers as applied in mobile phones, notebooks, tablets, gaming consoles, earphones, hands-free speakerphones, modern televisions and also in the automotive sector.

A general market trend shows that the structural shape of such loudspeakers does not allow a uniform design and demands great flexibility from manufacturers. In addition, smallest structural shapes with maximum performance are often demanded. Nevertheless, highest requirements are placed on the acoustic quality. All those requirements impose tremendous technological demands on the membrane, which functions as the centrepiece of a loudspeaker or microphone, respectively.

Silicone materials are preferred materials for acoustic membranes because of their desirable mechanical properties.

EP 2 268 058 discloses the use of a silicone elastomer in a membrane for a dynamic speaker, for example liquid silicone rubber (LSR), room temperature vulcanization rubber (RTV), and high temperature vulcanization rubber (HTV). The described membrane has a thickness of less than 0.3 mm. It may be produced by injection molding; said method is very preferred over deep drawing in this publication. However, injection molding is mainly suitable for producing large numbers of uniform membranes as this method does not easily allow design changes and requires a highest level of precision.

Moreover, elastic silicones were described to be desirable as damping layer or gluing layer in multi-layered membranes. For example in WO 2014/135620, silicones are suggested as material for a glue layer in a five-layered arrangement. Therein, the method suggested for producing the silicone layer is multi-roll coating, which may be considered as cumbersome.

WO 2016/091542 discloses the use of silicone based adhesives for a gluing layer as an inner layer in the context of multi-layered acoustic membranes. Therein, the adhesion material is preferably a pressure sensitive adhesive (PSA), which is a polymer material being sustainably sticky and permanently adhesive at application temperature (e.g. room temperature) and which adheres to various surfaces upon contact, particular adheres immediately. These properties, referred to as having a certain tack, are not present in standard silicone rubbers. US 2015/240141 discloses specific silicone PSA materials for acoustic membranes.

The thermal stability of the silicone elastomer is considered as an advantage in the application e.g. due to temperature variations occurring during service of the acoustic device. However, the thermal stability also may be considered as disadvantage for the production of multi-layer membranes with silicone materials. Injection molding is useful for producing a high number of pieces with identical shape and mono-layer arrangement, but is not easily adaptable for various shapes and for multi-layered membranes. Multi-roll coating may be applied to generate a multi-layer membrane with a silicone rubber layer. However, multi-layer membranes with a layer of silicone rubber are not preferred for subsequent thermoforming and may be exposed to high shear forces when those membranes are brought into a specific shape.

Thus, there is a need to provide alternative, more practicable ways for producing acoustic membranes with various shapes comprising elastomeric silicones.

### SHORT DESCRIPTION OF THE INVENTION

The present invention provides a composite material for producing an acoustic membrane comprising
a silicone layer comprising an at least partially uncured silicone rubber and
a support layer, wherein the support layer is adjacent to the silicone layer.

Such a composite material provides at least two layers forming a multi-layer film or foil. The support layer serves for support and protection of the uncured silicone or at least partially uncured silicone material (resin). In this arrangement, wherein the silicone layer is located adjacent to the support layer, it becomes possible to handle the (partially) uncured silicone in the form of a film layer of defined thickness. The silicone layer is provided in a state wherein it comprises at least a fraction of uncured silicone, i.e. the silicone layer is cross-linkable. The support layer adjacent to the silicone layer protects the underlying silicone layer against potential damages and allows for handling the composite material during packaging, e.g. winding, shipping, and processing, e.g. cutting. Due to the uncured character of the silicone rubber in the silicone layer, the composite allows the in situ curing of the silicone material during production of an acoustic membrane by thermal treatment or UV-light activation. Thus, the composite material allows to generate an acoustic membrane for an acoustic device from a pre-formed layered arrangement with predefined thickness.

This allows the production of an acoustic membrane with a specific three-dimensional form e.g. the formation of curvatures such as a torus region. Moreover, the composite material may include further layers that may become integral part of a multi-layered acoustic membrane. The composite material provides a valuable starting material for producing an acoustic membrane of various shapes and arrangements, wherein the silicone rubber maybe brought into shape upon curing the silicone rubber by e.g. application of heat or UV-light.

In the following, the term “partially uncured silicone rubber” is used both for a silicone rubber which is partially uncured as well as for a silicone rubber which is not cured at all.

The partially uncured silicone rubber that may form the silicone film preferably is an addition curing silicone rubber. The partially uncured silicone rubber may be provided as one-component or two-component system. Preferably, the partially uncured silicone rubber is a multi-component silicone rubber. In one embodiment, the silicone components comprise hydrogen-siloxane groups (Si—H) as well as vinyl groups (e.g. Si—CH═CH₂). The partially uncured silicone rubber preferably includes a catalyst for addition curing. For example the catalyst may be platinum which may be thermally activated for cross-linking (i.e. curing) the silicone rubber. The silicone may be a high-temperature vulcanizing (HTV) silicone rubber. Generally, platinum-catalyzed, addition-curing silicone rubber may be provided as liquid silicone rubber or as solid silicone rubber. For the present invention solid silicone rubbers are preferred. Alternatively, peroxide curing can be temperature controlled and also specific catalysts being sensitive to ultra-violet (UV) light are available for addition curing silicone rubbers.

Exemplarily, a schematic mechanism of cross-linking of a platinum cured HTV silicone resin, as it may be comprised in a silicone layer of a composite material according to the invention, is shown in the following reaction scheme:

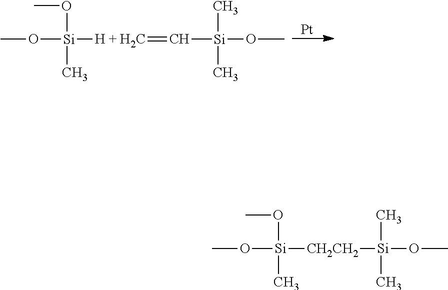

In this scheme, terminal methyl groups are indicated with CH₃, whereas the unspecified bonds indicate that the polymeric starting material is continued and that the shown chemical structure only represents a substructure of a silicone polymer.

Preferably, a high temperature vulcanizing silicone rubber as used according to the invention has a vulcanizing temperature of above 50° C., more preferably between 70° C. and 200° C., for example 130° C. The vulcanizing temperature may also be understood as a synonym to the temperature at which a curing process may be completed.

An uncured or partially uncured silicone rubber according to the invention is characterized in that it has a substantial fraction of reactive groups which allow cross-linking. In one embodiment the silicone layer comprising the partially uncured silicone rubber may also comprise a fraction of already cured silicone rubber. This may be achieved in that the uncured silicone rubber is provided in a partially cured state. The partially uncured silicone rubber is a uniform mass and comprises reactive groups as well as a fraction that is already cured.

Preferably, the partially uncured silicone rubber comprises a substantial fraction, e.g. above 50%, preferably above 70%, more preferably above 80%, of reactive groups (e.g. vinyl groups and/or Si—H groups) in relation to the completely uncured silicone rubber. Thus, the silicone layer may comprise an uncured silicone rubber or a partially uncured silicone rubber, preferably a largely uncured silicone rubber. The presence of reactive groups, i.e. the degree of uncured character of the silicone rubber, may be characterized by investigation of relative solvent resistance. Relative solvent resistance may be easily determined by a solvent rub resistance test. The test is inspired by the standard ASTM D4752 and determines the maximum number of rubs with cheesecloth soaked with a solvent until failure or breakthrough of the film occurs. Preferably, the test is performed with an aprotic solvent, e.g. toluene, cyclohexane, n-heptane, low boiling spirits fraction or a mixture thereof, preferably toluene.

In order to quantify the degree of curing, the solvent resistance of a test object is compared with a reference sample, wherein the reference sample comprises a comparable silicone layer in fully cured state, i.e. after heating the silicone layer to a temperature well above the vulcanizing temperature; for example after heating to above 130° C.

Thus, in one embodiment, the silicone layer comprising a partially uncured silicone layer has a relative solvent resistance of below 80%, preferably below 50%, wherein the relative solvent resistance is determined by a solvent rub test and defined by A/B, wherein A is the maximum number of rubs until breakthrough or failure of the investigated silicone layer, and wherein B is a reference value of the maximum number of rubs until failure of the reference sample.

In the present invention, the uncured silicone rubber after curing results in a silicone rubber having essentially no tack, wherein having a tack is understood as previously defined. Accordingly, the resulting cured silicone rubber, for example the reference sample mentioned above, shows no stickiness. With other words, the uncured silicone rubber is selected such that it does not form a pressure sensitive adhesive (PSA).

The partially uncured silicone rubber may also be characterized by the ultimate tensile strength (UTS) of the material, as the UTS of the partially uncured silicone rubber is above the UTS of the completely uncured silicone rubber and below the UTS of the cured silicone rubber. Thus, the partially uncured silicone rubber allows the silicone layer to be less fragile. Partial curing of the silicone rubber may be achieved during preparation of a composite material according to the invention (s. below).

The silicone film may additionally comprise an aprotic solvent. The aprotic solvent may be selected out the group consisting of toluene, cyclohexane, n-heptane, low boiling spirits fraction and a mixture thereof. Such aprotic solvents may be used to provide the components of the uncured silicone rubber as solution or dispersion. This allows the preparation of a fluid which enables the formation of uniform, thin layers of the uncured silicone, e.g. for roll-coating or curtain coating. Thus, in one embodiment the silicone layer may be formed by the component(s) of the silicone rubber, the catalyst and the aprotic solvent. However, the aprotic solvent preferably is removed from the silicone layer, so that the silicone layer essentially consists of the components of the silicone rubber, the catalyst and only residual fraction of solvent.

Moreover, in a preferred embodiment, the silicone layer may be provided without the use of a solvent. In these cases, the silicone layer may consist of the cross-linkable components of the silicone rubber and the catalyst, optionally without any further elements. Embodiments without any solvent may be provided in that a partially uncured silicone is shaped by calendering or extrusion (s. below). In these embodiments the silicone layer comprising a partially uncured silicone has a viscosity of above 0.001 MPa*s preferably above 0.01 MPa*s, wherein the viscosity is measured at room temperature and with a shear rate of about 1 Hz. The viscosity of the partially uncured silicone may be determined for example according to DIN EN ISO 2884-1.

Furthermore, the silicone layer may comprise polymer fibers selected from of the group consisting of PAEK (polyaryletherketone), e.g. PEEK (polyetheretherketone), PA (polyamide), PET (polyethylene terephthalate), PEN (polyethylene naphthalate), preferably PEEK. These fibers may be mixed into the uncured silicone during manufacturing of the composite material and result in reinforcement of the acoustic membrane.

According to one embodiment of the invention the silicone layer has a thickness of from 10 μm to 1000 μm or from 10 μm to 500 μm. In a further embodiment, the silicone layer has a thickness of from 10 μm to 300 μm, preferably from 20 μm to 200 μm, more preferably from 30 μm to 100 μm.

It is an advantage of the present invention that such a thin layer comprising uncured silicone may be provided. Consequently, the composite material according the invention allows for production of an acoustic membrane with a layer of cured silicone rubber in the desired dimensions of below 1000 μm, preferably below 500 μm or more preferably below 300 μm, such as around 30 μm.

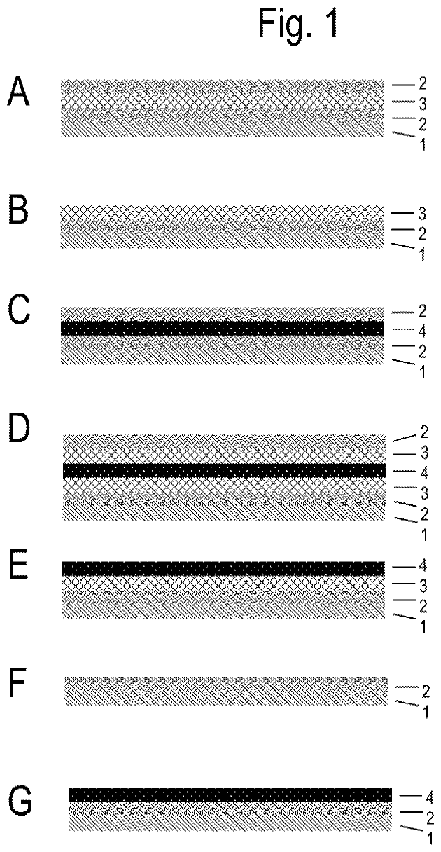

Thin layers are especially useful when the acoustic membrane is formed by multiple layers of different materials. Different multi-layer arrangements for acoustic membranes have been described previously. Various arrangements may be produced from the composite material according to the invention. The composite material according to the invention comprises at least two layers, however multiple-layers may be preferred and various layer arrangements for composite materials according to the invention are depicted in FIG. 1.

In general, two different embodiments of the composite material may be distinguished: the support layer may be either a release layer or a structure layer.

In each of the above embodiments the at least one support layer should be sufficiently stable, i.e. self-supported while still providing enough flexibility that the composite material may be rolled-up. The support layer may be characterized in that it has a higher ultimate tensile strength than the silicone layer comprising a partially cured silicone layer. The desired mechanical properties of a material suitable for a support layer may be determined following DIN EN ISO 527-1, wherein the obtained stress-strain diagram allows to determine tensile strength as well as Young's modulus. Young's modulus may be considered relevant to characterize a suitable material for a support layer. Preferably, the support layer comprises or consists of a material having a Young's modulus above 3 MPa. Preferably, the support layer has a Young's modulus above 3 MPa.

The composite material according to the invention has two outer layers and it is preferred that at least one of the outer layers is a support layer.

Preferably, the support layer is a release layer. A support layer being a release layer must be an outer layer which is removable without damaging the partially uncured silicone rubber layer. The support layer being a release layer preferably is removed before cross-linking of the silicone rubber i.e. before forming an acoustic membrane. Said release layer should be easily detachable from the remaining composite material, e.g. peeled off from the silicone layer comprising a partially uncured silicone rubber. Upon removal the composite material is converted to a precursor defined as the composite material minus the release layer. Thus, a release layer may be characterized in that a) the release layer is arranged as outer layer in a composite material according to the invention and b) the force for peeling off the release layer is lower than the lowest internal strength of the remaining material. For example the needed peel strength should be lower than the ultimate tensile strength of the partially uncured silicone layer, because this likely is the most vulnerable part of the remaining material.

Preferred materials for the support layer being a release layer may be selected by economic factors and the ability to be easily removed from the silicone layer. In general, any film or flat structure of various materials with the desired properties including polymers, biopolymers, or even inorganic materials might be suitable as a release layer. For example, suitable materials comprised in the release layer can be a polyethylene terephthalate (PET) film or a paper. Preferably the release layer is provided with surface modification e.g. by coating or impregnation, e.g. siliconised or olefin-coated, said surface modification may be present on only one or both sides, and a both-sided modification may be symmetric (i.e. the same on both surfaces) or differentiated for both sides. A differentiated modification means that the two surfaces of the layer differ from each other in their release properties. Suitable release layers may comprise a material selected from the group consisting of PET film with one-sided siliconization, PET film with symmetric siliconization, PET film with differentiated siliconization on both sides, paper with one-sided olefin coating, paper with symmetric olefin coating, and paper with differentiated olefin coating on both sides.

Preferably the release layer may have a thickness in the same range as the silicone layer, i.e. from 10 μm to 1000 μm, preferably from 10 μm to 500 μm or more preferably from 10 μm to 300 μm. For example a PET film may have a thickness of 50 μm or a release liner paper a thickness of 100 μm.

Alternatively, the support layer of the composite material is a structure layer. In contrast to the release layer, a structure layer is not removable from the composite material without damaging the silicone layer comprising partially uncured silicone rubber. Thus, it becomes integral part of the acoustic membrane. The support layer being a structure layer should still have the desired higher mechanical stability than the silicone layer in order to allow protection. Exemplarily, a structure layer may comprise a material selected from the group consisting of a polymeric film or a fabric, i.e. a non-woven fabric or a woven fabric. Preferably, the structure layer comprises a material that has been used in the preparation of acoustic membranes. For example thermoplastic materials, elastomers, fabrics such as woven fabrics or non-woven fabrics (e.g. fleece).

On the other side it is preferred that a structure layer provides enough flexibility/formability during further processing to an acoustic membrane, so that various shapes may be obtained without introducing relevant shear forces. Thermoplastic materials have the advantage that during production of an acoustic membrane by means of thermoforming the structure layer may be shaped while the silicone layer is cured by heat.

It is preferred that a structure layer comprises a thermoplastic material, such as a material selected from the group consisting of PAEK (polyaryletherketone), e.g. PEEK (polyetheretherketone), perforated PEEK (with punched holes), PEI (polyether imide), PAR (polyarylate), modified PAR types, PC (polycarbonate), PA (polyamide), PET (polyethylene terephthalate), PEN (polyethylene naphthalate), PPSU (polyphenylsulfone), PES (polyethersulfone) and PSU (polysulfone), preferably PEEK or the structure layer comprises a thermoplastic elastomer such as thermoplastic polyurethanes (TPU), polyester elastomers, co-polyester elastomers, styrene block copolymers like SBS (styrene-butadiene block copolymer) or SEBS (styrene-ethylene-butylene-styrene block copolymer), elastic co-polyamides, thermoplastic silicones, and elastomeric polyolefins.

In a further embodiment the structure layer comprises a fully cured silicone, e.g. the structure layer is another silicone layer that has a relative solvent resistance of above 80%, or even above 90%. Preferably, the structure layer comprises a fully cured silicone, wherein the fully cured silicone is formed by the same material as comprised in the silicone layer. This embodiment allows for producing an acoustic material made from uniform silicone material. Preferably, the other silicone layer forming the structure layer is a thinner layer than the silicone layer comprising a partially uncured silicone. With large parts of the silicone in the composite being a cross-linkable silicone rubber, the composite material still exhibits the desirable formability.

Any further layer of the composite material becoming integral part of the acoustic membrane may be termed performance layer as it will contribute to the acoustic and mechanical properties of the acoustic membrane. The performance layers comprise or may consist of various materials known to be suitable in acoustic membranes, e.g. thermoplastic materials, elastomers such as cured silicones, adhesives, but also fabrics such as woven fabrics or non-woven fabrics (e.g. fleece).

For example the performance layer may be a soft material such as a silicone material, acrylic material, thermoplastic elastomers said materials being known as suitable materials for providing acoustic damping and adhesion (damping or gluing layer).

Moreover, it is preferred that one performance layer becoming integral part of the membrane preferably is formed by a material which has a higher mechanical stability, i.e. stiffness, or higher elastic modulus, as the silicone rubber in uncured state. In case that the performance layer has a higher elastic modulus than the silicone material of the silicone layer after being cured it may also be termed reinforcement layer. In these cases, the reinforcement layer preferably comprises or consists of a material selected from materials which are as also preferred for the structure layer (s. above).

Preferably the reinforcement layer consists of a thermoplastic material, preferably a material selected from the group consisting of PAEK (polyaryletherketone), e.g. PEEK (polyetheretherketone), perforated PEEK, PEI (polyether imide), PAR (polyarylate), modified PAR types, PC (polycarbonate), PA (polyamide), PET (polyethylene terephthalate), PEN (polyethylene naphthalate), PPSU (polyphenylsulfone), PES (polyethersulfone) and PSU (polysulfone), thermoplastic polyurethanes (TPU), polyester elastomers, co-polyester elastomers, styrene block copolymers like SBS (styrene-butadiene block copolymer) or SEBS (styrene-ethylene-butylene-styrene block copolymer), elastic co-polyamides, thermoplastic silicones, and elastomeric polyolefins.

In one aspect, the present invention also provides a method for preparing a composite material according to the invention selected from the group consisting of
i) coating a support layer with a solution of an uncured silicone rubber in an aprotic solvent or
ii) laminating a support layer with a film of a partially uncured silicone rubber.

In a first method, the silicone layer is prepared by solution coating. The method may be conducted as a continuous, in-line process with the steps of
providing a support layer, for example a film of a thermoplastic material, a release paper, or a layer of cured silicone as described above. The surface of the support layer may be pretreated to modify the bonding properties. The pretreatment method depends on chemical and mechanical properties of the support layer and may include corona, plasma and flame treatment.
preparing the components of the silicone rubber as a solution. Suitable solvents are aprotic solvents as described above, e.g. toluene, and the solution may contain from 5% by weight to 50% by weight of the uncured silicone rubber, for example around 20 wt %.
coating the support layer with a solution of the silicone rubber. The concentration of the silicone components in the solution as well as dosing of the solution during coating will determine the thickness of the silicone layer in the composite material.
at least partially removing the solvent for example in a hot air flotation dryer tunnel, which may comprise different temperature zones. Preferably the temperatures for drying are below the vulcanizing temperature when a high-temperature vulcanizing silicone rubber is used, for example below 120° C., below 100° C., or 70° C.

In one embodiment, the solution coating method may include a step wherein the temperature is raised to a temperature in the range of the vulcanizing temperature of a high-temperature vulcanizing silicone rubber in order to allow partial curing, while it is essential that the silicone rubber at least partially remains uncured. Optionally, one or more further layer(s) may be introduced e.g. by covering the partially uncured silicone layer with a support layer or any further layer, before the composite material may be wound up.

In a second and preferred method of preparing a composite material according to the invention the partially uncured silicone rubber is directly deposited on a support layer. In order to achieve the desired thin layers of uncured silicone rubber the method may comprise a step of calendering or a step of extrusion through a slot die.

In one embodiment the method is conducted as an in-line process and includes the steps of
providing the component(s) of the uncured silicone rubber in a device that allows the portioned or continuous force conveyance for example in form of pads or parallel strings
feeding the uncured silicone rubber between at least two calenderer rolls, wherein the uncured silicone rubber is shaped into a flat continuous film. The thickness of the silicone layer will be influenced by the distance between the pressure rolls operating in opposing directions.
providing a support layer, e.g. a film of a thermoplastic material or release paper
depositing the film of uncured silicone rubber on the protection layer to obtain a laminate
calibrating the laminate.

Alternatively, the uncured silicone rubber is brought into the desired thickness by extrusion. In this case the transport is also achieved by force conveyance.

During extrusion it must be controlled that the silicone rubber is not fully cured. Preferably the processing system is cooled, especially the die is cooled to maintain a processing temperature of well below the vulcanizing temperature of the silicone rubber, e.g. below 70° C. In an extrusion setup the use of a multilayer die may enable that a silicone layer and another layer, e.g. a thermoplastic material are co-extruded. For example a silicone layer and a reinforcement layer may be co-extruded and simultaneously deposited on a release layer to obtain an arrangement according to FIG. 1G.

In another aspect, the invention provides a process for producing an acoustic membrane comprising the steps of
providing a precursor by cutting a composite material according to the invention in a suitable two-dimensional extension
shaping the precursor obtained in a previous step by using a forming tool and by exposing said precursor to conditions that allow the uncured silicone rubber to cure.

The precursor is prepared in that the film is tailored to an appropriate size for the subsequent forming and curing step. The precursor may be a composite material or optionally—in case the composite material is an embodiment with the support layer being a release layer—derived from a composite material by removing the release layer.

For producing an acoustic membrane from the preferred composite material arrangements including a release layer, the release layer is removed before curing the silicone layer. Thus, in a preferred embodiment the method comprises a step of removing the release layer(s) to obtain the remaining silicone layer or the silicone layer in a multi-layer arrangement with one or more further layer(s) before the step of shaping and curing the precursor. In a subsequent step the composite material or the material remaining after removal of the release layer, i.e. the precursor, is formed and the silicone layer cured.

Forming, i.e. providing the material in the appropriate three-dimensional arrangement for the intended shape of the membrane, may be achieved by one or more forming tools.

Additionally, a pressure chamber may be used to allow forming by vacuuming or pressurizing.

Suitable conditions for curing depend on the partially uncured silicone rubber comprised in the silicone layer. Input of heat may be achieved by heating of the forming tool(s) or by thermal radiation, e.g. by using an infra-red (IR) source. Alternatively, silicone layers with a UV-curing silicone rubber may be exposed to a source of UV-light. In case of thermoforming, suitable conditions to achieve curing of an uncured or partially uncured silicone layer may be exposed to 130° C. to 250° C. for a time period of 1 min to 5 min, thus allowing the uncured silicone rubber to cure. However, heating conditions will vary with the used silicone rubber and the thickness of the membrane. Moreover, the reaction time may be reduced with increased temperature, e.g. for curing thin films 3 min at 150° C. may be as sufficient as 1 min at 180° C.

The process for producing an acoustic membrane, especially when using IR-initiated cross-linking allows for a time efficient production process in comparison to injection molding or deep drawing.

### DETAILED DESCRIPTION OF THE INVENTION

In the following aspects of the invention are described in figures and examples to illustrate embodiments of the invention. These embodiments should be understood as exemplary non-limiting examples.

FIG. 1 A to N show various preferred arrangements of a composite material according to the invention with a support layer 1 or 5 and a silicone layer 2, optionally comprising further layers (3, 4, 6).

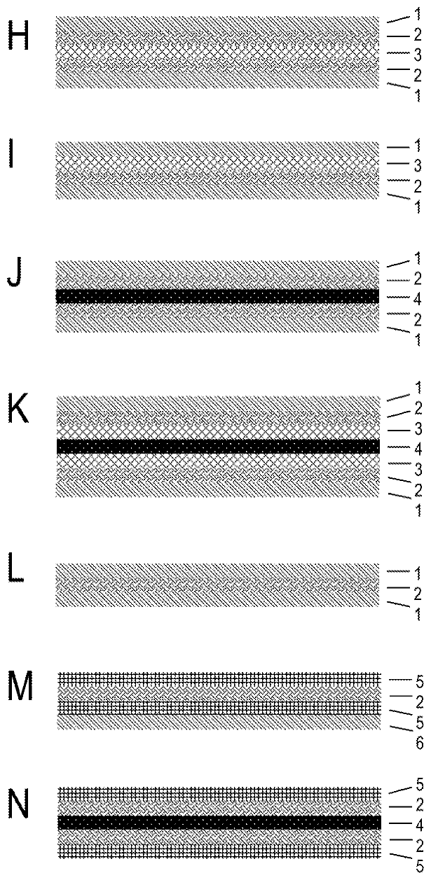

FIG. 2 shows a schematic view of a solution coating process useful in method suitable for preparing a composite material.

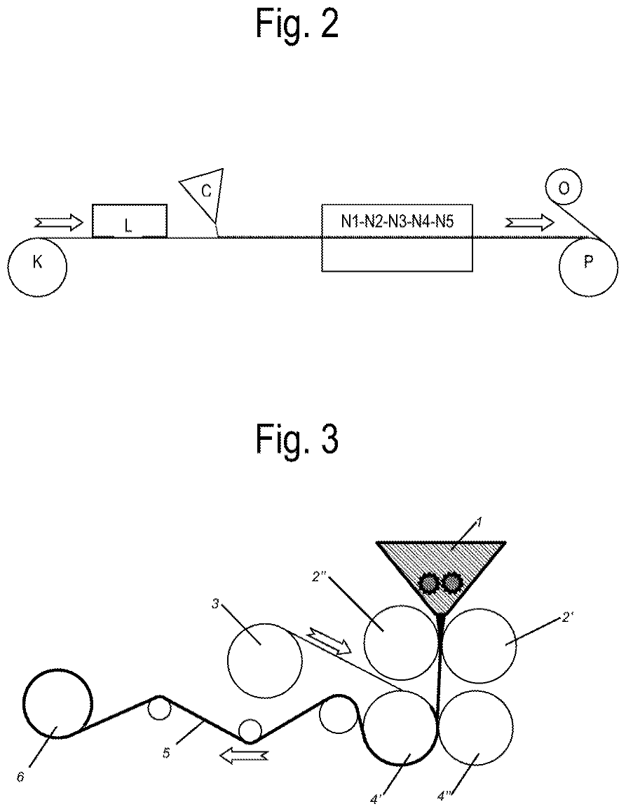

FIG. 3 shows a schematic view of a calendering-based method suitable for preparing a composite material.

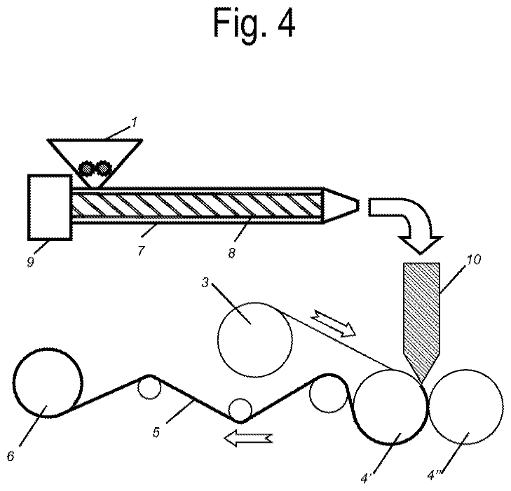

FIG. 4 shows a schematic view of an extrusion-based method suitable for preparing a composite material.

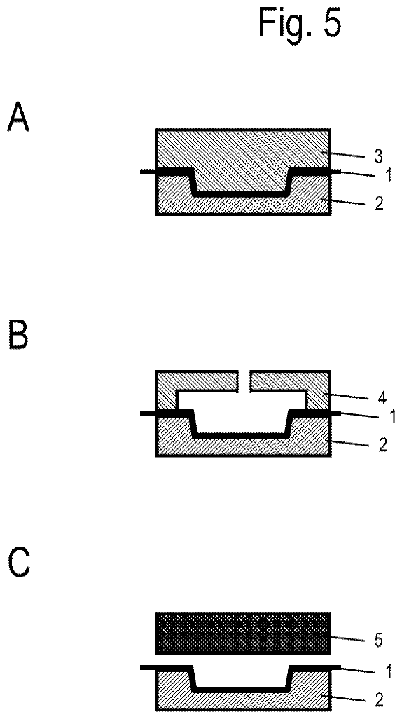

FIG. 5 shows alternative forming procedures suitable in a process of forming an acoustic membrane.

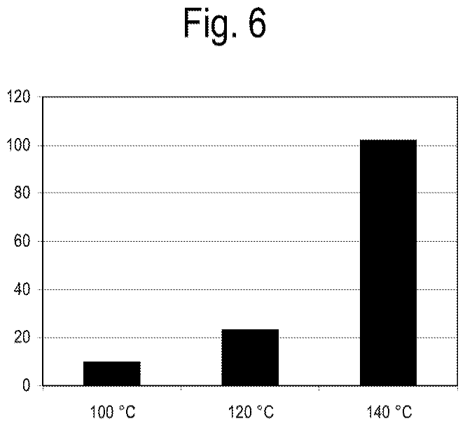

FIG. 6 shows results for a solvent resistance rub test performed with toluene for three comparable composite materials, wherein the materials were pretreated at the indicated temperature and the ordinate is labeled with the number of double rubs.

### EXAMPLES

### Different Arrangements for a Composite Material According to the Invention

FIGS. 1 A to N show different arrangements of composite materials according to the invention with at least one support layer 1 or 5 and a silicone layer 2. They may be composed for example as follows:

In the preferred arrangements of Fig. A to L a support layer is the bottom outer layer of the arrangement. Words such as “top” and “bottom” are not meant to indicate a certain orientation of the membrane, but are merely used to describe the figures in a pictorial way. Here, the support layer is a release layer 1 and said release layer 1 may be removed from the composite material. In the arrangements of Fig. H to L, the top outer layer is also a support layer being a release layer 1. Preferred materials for the release layer designated with 1 are for example PET film with one-sided siliconized surface, PET film with symmetric siliconized surfaces, PET film with differentiated siliconized surfaces, paper with one-sided olefin coating, paper with symmetrically olefin-coated surfaces, and paper with differentiated olefin coating on both sides. These layers preferably have a thickness in the range of 30 μm to 200 μm, for example around 100 μm.

Moreover, the preferred embodiments of FIG. 1 A to L share a first silicone layer 2 positioned directly adjacent to the release layer 1. Thus, the silicone layer 2 forms an outer layer after removal of the release layer 1, i.e. in a precursor for preparing an acoustic membrane. In embodiments of FIGS. 1 A, C, D, and F a second silicone layer 2 forms the top outer layer of the composite material. Thus, these silicone layers 2 are surfaced-exposed. In order to protect the fragile partially uncured silicone rubber in an outer layer, these embodiments should preferably be wound up to a roll for storage and transportation, wherein the support layer 1 is facing the outside of the roll. Consequently, also the top outer layer 2 is protected. In these cases an asymmetrically modified release layer 1 is preferred, i.e. with one-sided or differentiated modification, wherein the adhesion to the adjacent silicone layer should be considerably higher than the adhesion to the outside of the arrangement. This allows that the composite material can be unwound from the roll while maintaining its original arrangement.

The silicone layer in a composite material according to the invention preferably is a high-temperature vulcanizing silicone rubber, preferably a solid, two component material including a catalyst. Suitable silicone rubbers are commercially available. The silicone layer in the preferred embodiments has a thickness of below 100 μm, for example around 30 μm.

Furthermore, the multilayered arrangements with three or more layers may comprise a performance layer wherein the reference sign 3 indicates one or more damping layer(s) and the reference sign 4 indicates a reinforcement layer. Preferred materials for a damping layer 3 are soft materials. In the embodiments of FIGS. 1 A, B, D, E, H, I, K and L the damping layer consist of a material selected from the group consisting of an uncured silicone layer, a partially uncured silicone layer or a cured silicone layer, especially a silicone layer being softer than the silicone layer 2, a silicone gel or a pressure sensitive adhesive based on a silicone or acrylic material. A damping layer 3 preferably has a thickness in the range of 5 μm to 200 μm, for example 10 μm.

Preferred materials for the reinforcement layer 4 in embodiments of FIGS. 1 C, D, E, G, J, K and N may be PAEK, PEEK, e.g. perforated PEEK, PEI, PAR, PA, PET, PEN, PSU, PPSU, thermoplastic elastomers, silicones and also non-woven textile material such as fleece or also woven fabrics. The reinforcement layer preferably has a thickness in the range of below 20 μm or even below 10 μm, for example a 6 μm perforated PEEK layer.

In the embodiments of FIG. 1 M, the two support layers are structure layers 5. For example the layers 5 consist of cured silicone, e.g. thin silicone layers made out of the same starting materials as the adjacent silicone layer 2. However, the structure layers 5 are in the cured state. These embodiments allow for producing an acoustic material of a uniform silicone material. Additionally, this embodiment includes an optional layer 6, which may be formed by a material as described for the release layer and is removable.

FIG. 1 N shows an exemplary embodiment, wherein the support layer is a structure layer 5. This structure layer 5 is for example a cured silicone layer. Exemplarily, a structure layer being a cured silicone layer was investigated for mechanical properties and shown to have a Young's modulus above 3 MPa, e.g. around 4 MPa, and a tensile strength of 12 N/mm² as measured for a strip of 20 mm and a thickness of 100 μm according to DIN EN ISO 527-1. In contrast, for a silicone layer comprising a partially uncured silicone rubber the deformation upon exposition of a tensile force is irreversible and therefore a Young's modulus can not be determined. The cured silicone as structure layer 5 protecting the underlying uncured silicone layer 2 was found to be extremely valuable for producing and handling of the composite material. For reasons of acoustic behavior and stability, it may be preferred that the composite material additionally comprises a further layer with higher mechanical stability. For example, in FIG. 1 N, the reinforcement layer 4 preferably is selected out of PAEK, PEEK, e.g. perforated PEEK, PEI, PAR, PA, PET, PEN, PSU, PPSU.

### Preparation of a Composite Material According to the Invention by a Coating Procedure

FIG. 2 shows a schematic view of an in-line coating process, wherein the subsequent individual steps are operated from left to right as indicated by arrows. For production of a composite material according to the invention, first, a support layer, i.e. a rolled-up film or paper material, is provided from an unwind station K.

In the elongated state the support layer may be subjected to a surface treatment. For example the support layer may be exposed to plasma or corona treatment as indicated with L in FIG. 2. An advantage of these surface treatments may be a modified interaction of the support layer and the subsequently applied coating. However, the surface treatment is only optional in a method according to the invention.

Essential step of the coating process is the coating itself as indicated with C in FIG. 2. Here a solution of silicone rubber component(s) is applied on the support layer film. The inventors obtained a suitable solution for application in curtain coating with a solution of 20% by weight of a high-temperature vulcanizing Pt-catalyzed solid silicone material in toluene.

The large part of the solvent may be removed in a flotation dryer. In FIG. 2 a flotation dryer is visualized with multiple zones N1 to N5, wherein the temperature may be regulated individually in the zones. Removal of toluene for example was achieved with a temperature of below 80° C., for example with a maximum temperature of 70° C. These temperature ranges do not induce the curing of the silicone rubber and allow preparation of a composite material with an essentially uncured silicone rubber. Alternatively, temperatures above 80° C. may be shortly applied during drying, wherein partial curing is intended. Higher temperatures, e.g. above 100° C. may initiate the curing process. By use of different temperature zones the degree of curing may be controlled, e.g. by reducing the temperature in the subsequent zone. Thus, the coating process allows a person skilled in the art to vary the parameters in order to obtain an at least partially uncured silicone in the silicone layers with different degrees of pre-curing.

After flotation drying, schematically depicted with a second arrow in FIG. 2, a composite material according to an arrangement of FIG. 1 F is prepared. Optionally, further layers may be introduced. FIG. 2 shows an unwind station O, where another support layer, e.g. a release layer, may be provided to be placed on top of the silicone film before the composite material is rolled up. The resulting multi-layered composite material, for example in an arrangement according to FIG. 1 L, is rolled up on the rewind station P. The additional support layer provided on the unwind station O may also be a reinforcement layer yielding in an arrangement according to FIG. 1 G or the unwind station O may also provide a multi-layered film (e.g. another composite material according to the invention) to achieve more complex arrangements. The person skilled in the art may also easily concept an installation with an additional unwind stations to introduce further layers into the obtained composite material.

### Preparation of a Composite Material by a Laminating Method

FIG. 3 shows a schematic view of an installation useful for an additional method for preparing a composite material according to the invention. Here, the components of an uncured silicone layer are provided directly in a feed 1, wherein the gear wheels symbolize a mean of mixing and displacing the solid or highly viscous silicone rubber material. The silicone mass is displaced by forced conveyance and fed forward to a calenderer visualized with two pressure rolls 2′ and 2″ rotating in opposite directions. Suitable parameters for calendering depend on the mechanical properties of the uncured silicone rubber.

After calendering, the uncured silicone rubber is deposited on a support layer. The support layer, e.g. a thermoplastic film or paper, is provided from an unwind station 3 and processed in the running direction as indicated by the arrow. Immediately, after depositing of the silicone on the support layer, the lamination process is continued by two calibrating rolls 4′ and 4″. Subsequently, the composite material 5 may be moved over several rolls along the running direction. Here, optionally different parameters may be selected for smoothening of the surface and controlling the thickness of the silicone layer. Also temperature gradients or irradiation may be applied to allow controlled pre-curing of the silicone rubber. Finally, the composite material is rolled up on the rewind station 6.

In a preferred variation, the method may be performed as indicated in FIG. 4. Here, the uncured silicone rubber is pre-processed in an extruder. The uncured silicone rubber is supplied to the barrel 7 of the extruder via the feed 1. Within the barrel 7 the silicone rubber is displaced by force conveyance, for example by a screw 8 which is moved by a motor 9. In order to prevent curing of the silicone rubber during processing in the extruder, the elements of the extruder being in contact with the silicone rubber mass are cooled. It is ensured that the temperature within the barrel 7 does not reach the critical temperature for vulcanizing the silicone rubber. The output of the extruder is subjected to a slot die 10 as indicated by the arrow. Especially, the die 10 should be cooled in order to prevent that the critical temperature for curing of the silicone is reached. Said die 10 may also be a multi-layer die allowing for generation of composite materials with more than two layers. The silicone rubber layer or multiple layers sorting from the slot die is/are deposited on a support layer. The subsequent processing of the laminate is conducted as described above.

### Process for Producing an Acoustic Membrane

In a process of producing an acoustic membrane with a composite material according to the invention, the composite material first has to be prepared. The material should be cut into an appropriate size, said size being for example marginally larger than the intended dimension of the acoustic membrane for lateral allowance during forming. Additionally, the removal of one or more release layers may be a step in preparation of composite material. Thus, the precursor may preferably comprise the silicone layer as outer layer.

In a second step, curing of the silicone rubber is achieved to shape the precursor into the desired form of the acoustic membrane. Exemplary, suitable tools are schematically shown in FIG. 5. The flexible composite material or precursor 1 may be brought into the desired form by a shaping tool. The tools in FIG. 5 provide for example a shape that allows producing an acoustic membrane with a central recess. Generally the process of curing the silicone rubber in the silicone layer may be initiated by heat, if thermo-sensitive catalysts are comprised in the silicone rubber or alternatively by UV-light, if photo-initiators are present in the silicone rubber. Thermo-sensitive rubbers are preferred in composite materials according to the invention.

FIG. 5 A shows a thermoforming tool with a lower part 2 and an upper part 3, with the precursor being positioned between the two parts. The parts may be heated and by conduction the temperature in the silicone layer is raised to reach a temperature above the vulcanizing temperature. Thereby, curing of the high-temperature vulcanizing silicone is initiated or completed in case of partially cured silicone layer.

FIG. 5 B shows a variant of a thermoforming tool wherein the upper part 4 builds a pressure chamber. Vacuum or pressure may be applied to bring the precursor 1 into the desired shape, e.g. in this case by pressing the precursor 1 onto the lower part 2. For curing, the lower part of the thermoforming tool may be heated, or preferably forming in a pressure chamber may be combined with subsequent initiation of curing by radiation.

UV-radiation is the method of choice for curing UV-sensitive silicone rubbers. However, also thermo-sensitive silicone rubbers may be cured by radiation, e.g. by use of an infrared (IR) source. In FIG. 5 C, an IR source is indicated with the reference sign 5 to symbolize the initiation of curing by exposing the precursor 1 to thermal radiation. Heating via a radiation source is preferred because the onset and time of heating process can be controlled more accurately. Curing by radiation may be faster and more efficient than by heating the forming tool(s).

### Solvent Resistance Rub Test

A solvent resistance rub test was performed in order to characterize the partially uncured silicone layer in composite materials according to the invention. The rub test is performed on basis of the standard ASTM D4752 and involves rubbing the surface of the silicone layer with cheesecloth soaked with toluene until failure or breakthrough of the film occurs. The type of cheesecloth, stroke distance, stroke rate, and approximately applied pressure of the rub should be identical for all tests. The higher the number of rubs, said rubs being counted as double rubs, the higher is the solvent resistance of the investigated layer. FIG. 6 shows the results for three composite materials, wherein all three have a silicone layer of 40 μm and they were heated to the indicated temperature for 5 min. The ordinate indicates the number of double rubs needed until failure or breakthrough of the respective material.

Heating to 140° C. results in a completely cured silicone layer, i.e. further curing for higher temperature or longer time did not result in increased solvent resistance. Thus, the composite material heated to 140° C. is a reference sample representing a cured state. The two embodiments heated to 100° C. or 120° C. are composite materials according to the invention with a partially uncured silicone rubber. The relative solvent resistance may be determined by dividing the achieved number of double rubs by the number of double rubs achieved with the completely cured reference material. The embodiment pre-treated at 100° C. has a relative solvent resistance of 9.8% and the embodiment pre-treated at 120° C. has a relative solvent resistance of 22.5%.

1. A composite material for producing an acoustic membrane, wherein the composite material comprises at least:
a silicone layer comprising an at least partially uncured silicone rubber; and
a support layer, wherein the support layer is adjacent to the silicone layer.

2. A composite material according to claim 1, wherein the at least partially uncured silicone rubber is a high temperature vulcanizing addition-curing silicone rubber.

3. A composite material according to claim 2, wherein the silicone layer (2) comprises:
a first silicone component with a Si—H substructure,
a second silicone component with a Si-vinyl substructure, and
a catalyst.

4. A composite material according to claim 3, wherein the catalyst is platinum.

5. A composite material according to claim 1, the silicone layer comprising an at least partially uncured silicone having a relative solvent resistance of below 80%, or below 50%.

6. A composite material according to claim 1, wherein the silicone layer further comprises an aprotic solvent.

7. A composite material according to claim 6, wherein the aprotic solvent is selected from the group consisting of toluene, cyclohexane, n-heptane, low boiling spirits fraction and mixtures thereof.

8. A composite material according to claim 1, wherein the silicone layer has a thickness of from 10 μm to 300 μm, or from 20 μm to 200 μm, or from 30 μm to 100 μm.

9. A composite material according to claim 1, wherein the composite material comprises one or two silicone layer(s), one or two support layer(s), and optionally one or more further layer(s), wherein the one or more further layer(s) is/are selected from the group consisting of damping layers and reinforcement layers.

10. A composite material according to claim 1, wherein the support layer is a release layer or a structure layer.

11. A composite material according to claim 10, wherein the composite material comprises two outer layers characterized in that at least one of the outer layers is a support layer and wherein the support layer is a release layer.

12. A composite material according to claim 11, wherein the release layer comprises a polyethylene terephthalate (PET) film or a paper, selected from the group consisting of PET film with one-sided siliconization, PET film with symmetric siliconization on both sides, PET film with differentiated siliconization on both sides, paper with one-sided olefin coating, paper with symmetric olefin coating on both sides, and paper with differentiated olefin coating on both sides.

13. A composite material according to claim 10, wherein the support layer is a structure layer.

14. A composite material according to claim 13, wherein the structure layer comprises:
a thermoplastic material selected from the group consisting of PAEK (polyaryletherketone), e.g. PEEK (polyetheretherketone), PEI (polyether imide), PAR (polyarylate), modified PAR types, PC (polycarbonate), PA (polyamide), PET (polyethylene terephthalate), PEN (polyethylene naphthalate), PPSU (polyphenylsulfone), PES (polyethersulfone), and PSU (polysulfone), or
an elastomer selected from the group consisting of urethane elastomers, polyester elastomers, co-polyester elastomers, styrene block copolymers like SBS (styrene-butadiene block copolymer) or SEBS (styrene-ethylene-butylene-styrene block copolymer), elastic co-polyamides, elastomeric polyolefins, and acrylic elastomers, or
a cured silicone.

15. A method for preparing a composite material according to claim 1 comprising:
i) coating a support layer with a solution of an uncured silicone rubber in an aprotic solvent; and/or
ii) laminating a support layer with a film of an at least partially uncured silicone rubber.

16. A method according to claim 15, wherein a method that includes item i) further comprises a step of essentially removing the aprotic solvent.

17. A method according to claim 15, wherein a method that includes item ii) comprises a step wherein the film of the at least partially uncured silicone rubber is shaped by calendering or extrusion before depositing the film on the support layer.

18. A process for producing an acoustic membrane from a composite material according to claim 1 comprising the steps of
providing a precursor by cutting the composite material in a suitable two-dimensional extension, and
shaping the precursor by using a forming tool and by exposing said precursor to conditions that allow the uncured silicone rubber to cure.

19. A process according to claim 18, wherein the precursor is derived from a composite material comprising two outer layers characterized in that at least one of the outer layers is a support layer and wherein the support layer is a release layer, and wherein the method comprises a step of:
removing the release layer(s) before the step of shaping the precursor.

20. A process according to claim 18, wherein the conditions allowing the uncured silicone rubber to cure are achieved by raising the temperature of the silicone layer to a temperature of 100° C. or higher, or to a temperature of from 140° C. to 200° C.
